(19) United States
(12) Patent Application Publication
(10) Pub. No.: US 2022/0272415 A1
(43) Pub. Date: Aug. 25, 2022

(54) DEMONSTRATION OF MOBILE DEVICE APPLICATIONS

(71) Applicant: salesforce.com, inc., San Francisco, CA (US)

(72) Inventors: Mathew Kwok, San Francisco, CA (US); Jonathan Day, San Francisco, CA (US)

(73) Assignee: salesforce.com, inc., San Francisco, CA (US)

(21) Appl. No.: 17/249,230

(22) Filed: Feb. 24, 2021

(51) Int. Cl. H04N 21/478; H04W 4/50; H04N 21/414; H04N 21/45; H04N 21/482; H04N 21/485; H04L 29/06

(52) U.S. Cl. CPC H04N 21/478; H04W 4/50; H04N 21/41407; H04N 21/4518; H04N 21/482; H04N 21/485; H04L 67/38

(57) ABSTRACT

A method and apparatus for generating a presentation including a device demonstration including a user interface for receiving a first user command defining a parent record including a presentation element, a first client record including the first device, and the first input, and a second client record including the second device and the second input; the user input further configured for receiving a first display command and a second display command, and a processor for generating a user interface having a first view configured including the first video content within a first graphic associated with the first device and the presentation element and coupling the first view to a display device, the processor further configured for generating a second view including the second video content within a second graphic associated with the second external device and coupling the second view to the display device.

### TECHNICAL FIELD

Embodiments of the subject matter described herein relate generally to user interface design and configuration. More particularly, embodiments of the subject matter relate to providing a consistent demonstration of mobile device based applications in a presentation by associating predetermined video streams with slide locations and device associated frames.

### BACKGROUND

Today's computer application developers must provide attractive and engaging presentations to demonstrate their applications to stand out from their competitors. With the proliferation of connected devices, such as mobile phones, smart watches, smart appliances and the like, many applications may run on different platforms or across multiple platforms. Providing customer demonstrations requires demonstrating these applications on the multiple platforms to potential users in a coherent and engaging way.

Difficulty arises when providing demonstrations using multiple devices, such as computers, mobile phones, smart watches, etc., in that the video outputs must be switched from one source to another during the presentation, disrupting the flow of the presentation and providing an inconsistent visual look to the presentation to the viewer. Breaks in the presentation are disruptive and distract viewers from the message of the demonstration provider. Accordingly, it is desirable to overcome these problems and provide an improved method and apparatus for providing a bypass block mechanism for webpage navigation in a user interface.

Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 shows a first exemplary application for implementation and utilization for simulating mobile device applications according to an embodiment of the present disclosure.

FIG. 2 shows a second exemplary application for implementation and utilization for simulating mobile device applications according to an embodiment of the present disclosure.

FIG. 3 shows a third exemplary application for implementation and utilization for simulating mobile device applications according to an embodiment of the present disclosure.

FIG. 4 is a block diagram of a system for simulating mobile device applications according to an exemplary embodiment of the present disclosure.

FIG. 5 is a flowchart of a method for simulating mobile device applications according to an exemplary embodiment of the present disclosure.

FIG. 6 is block diagram of another exemplary system for simulating mobile device applications according to an exemplary embodiment of the present disclosure.

FIG. 7 is a flowchart of another method for simulating mobile device applications according to an exemplary embodiment of the present disclosure.

The exemplifications set out herein illustrate preferred embodiments of the invention, and such exemplifications are not to be construed as limiting the scope of the invention in any manner.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

When providing a demonstration of a new product or application to an audience, it is desirable to maintain a consistent look to the presentation, such as using the same presentation background, fonts, etc. The current systems and methods facilitate demonstration of mobile device based applications within a device frame in an application window or web browser having a consistent look, such as consistent background, logos, fonts or the like. The system may take in different live video feeds, live screen shares, websites, progressive web apps, display them in a consistent format. Likewise, it is disruptive to the demonstration to keep switching between content sources and the like. Typically, high quality presentations require the use of a video processor, video switching matrix, and video operator in addition to the presenter. The presently disclosed system and method teaches a system for simulating mobile notifications and other mobile screens on a variety of mobile devices without having to take time to switch sources during the presentation and risk losing the audience's attention. The system may display images, websites, video, and device video output in a variety of bezels, with smooth transitions between each state. In addition, the exemplary system may enable a picture-in-picture image a PIP of the presenter during a demo.

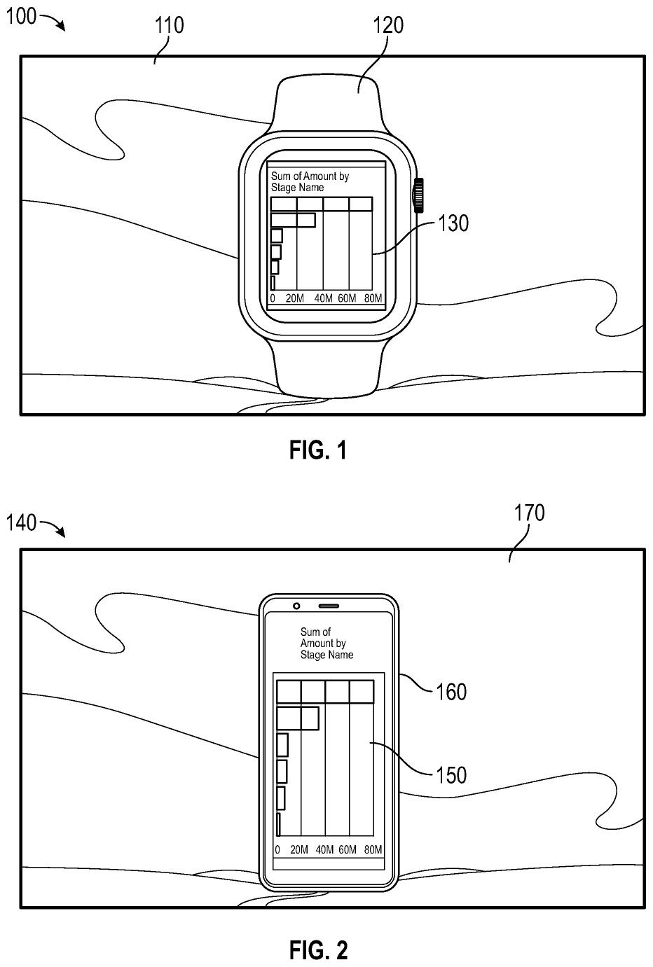

Turning now to FIG. 1, a first exemplary application 100 for implementation and utilization for simulating mobile device applications according to an exemplary embodiment of the present disclosure is shown. The first exemplary application 100 illustrates a presentation of a smart watch application presented during a demonstration projected on a presentation screen. The presenting device displays a background 110 and a bezel 120 associated with a device. In this example, the device is a smart watch. The presenting device then receives a video stream of a display from the device and presents the video stream 130 within the bezel 120. Thus, the viewers of the presentation are seeing an actual video stream of a device running an application, presented on a consistent background with a bezel associated with the device running the application. In various examples, the bezel, background, and source of the video stream are all designated ahead of time, so when the slide is presented during the demonstration, all of the connections are predefined and made automatically so no time is wasted during the presentation.

Turning now to FIG. 2, a second exemplary application 100 for implementation and utilization for simulating mobile device applications according to an exemplary embodiment of the present disclosure is shown. The second exemplary application 140 illustrates a smartphone application 150 displayed on a background 170 and within a bezel 150 associated with the smartphone. As can be seen in comparison to FIG. 1a, the background 170 has remained consistent, the bezel has been changed in response to an association with the new device and video stream 150 from the smartphone application. Since devices, video sources, bezels and the like may be selected before the presentation, when a presenter switches between the slide of FIG. 1 and the slide of FIG. 2, the video sources are automatically switched and the associated bezels are automatically displayed.

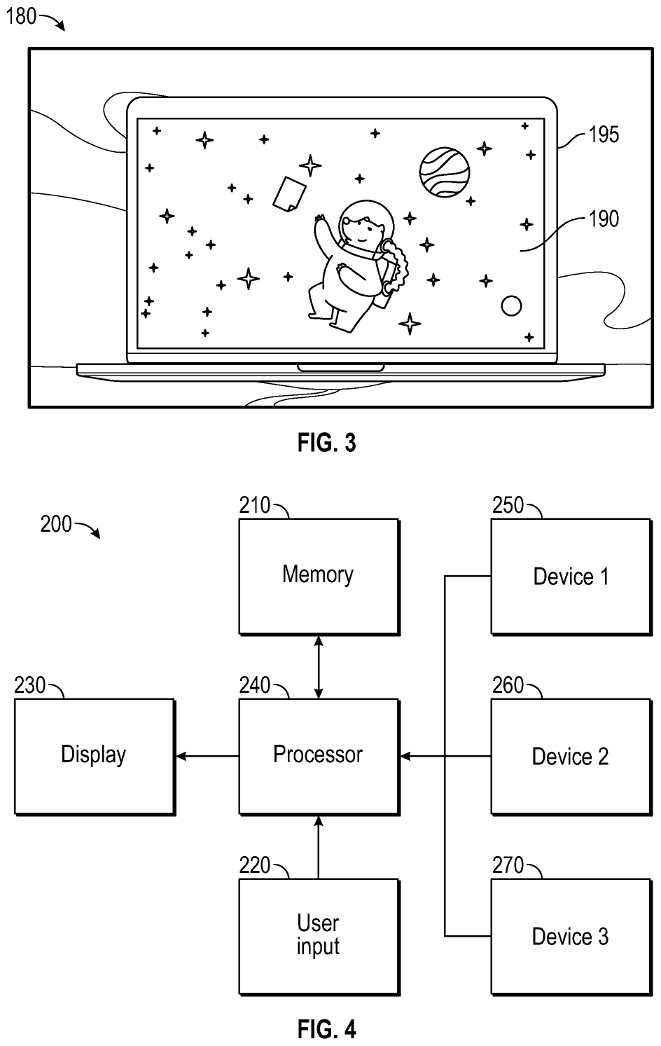

Turning now to FIG. 3, a third exemplary application 180 for implementation and utilization for simulating mobile device applications according to an exemplary embodiment of the present disclosure is shown. The third exemplary application 180 illustrates a video feed from a laptop displayed within a bezel representing a laptop. The presently taught system is equally applicable to other systems such as medical devices; GPS devices, smart appliances, wearable devices, fitness tracker, media player, vehicle based system, instrument panels, etc.

Turning now to FIG. 4, a functional block diagram of a system 200 for simulating mobile device applications according to an exemplary embodiment of the present disclosure is shown. The exemplary system 200 may be performed by computer, web server or other electronic device for receiving audio/video streams and presenting a demonstration to viewers. The exemplary system may include a processor 240, a memory 210, a user input 220, a display 230, a first device 250, a second device 260 and a third device 270.

The processor 240 may be configured to receive an instruction from a user input 220 wherein the instruction denotes at least a presentation format and a first device 250. The processor 240 is then configured to retrieve data from the memory related to the presentation format, such as a presentation background, font, images or the like, and an image associated with the first device 250. For example, if the first device 250 is a XYZ model computer tablet, the processor 240 may retrieve an image associated with the XYZ model computer tablet, such as an image of a tablet bezel. The processor 240 may further receive an indication of a video source associated with the first device 250. Alternatively, the processor 240 may determine a video source and/or video stream associated with the first device 250.

The processor 240 is then configured to generate a graphical user interface in response to the data related to the presentation format, the image associated with the first device 250 and the video source. For example, the graphical user interface may include a background image associated with the presentation format, a bezel image associated with the first device 250 and the video source. The video source may then be displayed within the bezel image with the background image as a background. The processor 240 may then couple the graphical user interface to the display 230.

The system 200 may be configured for receiving instructions via the user input 220 indicative of a presentation format, a first device 250, a second device 260 and a third device 270. For example, the instructions may indicate a presentation background, a source of a first video stream and the first source type, a source of a second video stream and the second source type, and a source of a third video stream and the third source type. The instructions may further include a slide order, an association between a slide number and a device and/or signal source and the like. For example, the presentation may be completely configured with associations between slides, devices and signal sources, as well as other associated content such as text, images, video, animations and the like, before the presentation is displayed. Thus, when a user changes slides during a presentation, all of the associations are predefined and the video stream from the desired device with the desired image associated with the device, the desired background and the desired associated content are automatically displayed.

In response to the instructions received via the user input 220, the processor 240 may then generate a graphical user interface using the presentation background, an image associated with the first source type retrieved from the memory 210, and the first video stream. The processor 240 may then couple this graphical user interface to the display 230 for presentation to an audience. The processor 240 may then receive a user input indicative of a slide change via the user input 220. For example, a user may press a page down key on a keyboard indicating that the user desires to change the slide in the presentation. In response to the user input indicative of a slide change, the processor 240 may then generate a graphical user interface using the presentation background, an image associated with the second device 260 retrieved from the memory 210 and the second video stream. To a viewer, the presentation would then appear to be representative of the second device 260 with a video stream from the second device 260 displayed on the same background as the prior user interface resulting in a consistent look.

A third user input indicative of a slide change via the user input 220 may be received by the processor 240. The processor may then generate a third graphical user interface using the presentation background, an image associated with the third device 270 and the third video stream. The presentation would then appear to be representative of the third device 270 with a video stream from third device 270 displayed on the same background as the prior user interface resulting in a consistent look.

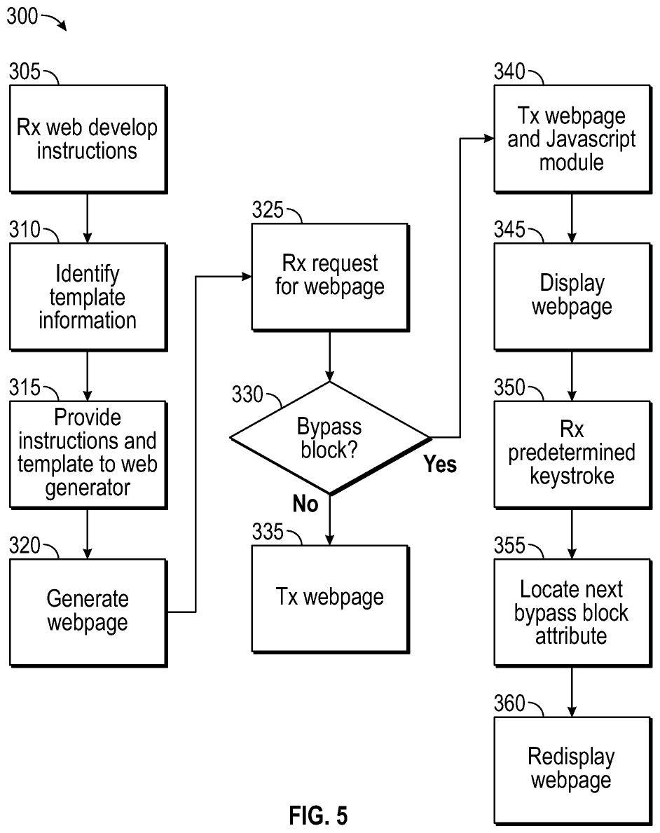

Turning now to FIG. 5, a flowchart of a method for simulating mobile device applications according to an exemplary embodiment of the present disclosure is shown. The method is first configured to receive 305 presentation details. The presentation details may be indicated via a user interface, such as a keyboard, and received from a memory, network interface, electronic storage device, or the like. The presentation details may include a background image for display during a demonstration or presentation, images, graphics, sounds, text, and other audio video content to be displayed on a plurality of consecutive slides.

The method is next operative to generate 310 a parent record in response to the presentation details. The parent record may act as a container for one or more of the child records. The parent records may provide a consistent background over which graphics from a child record may be displayed.

The method may next generate 315 a first child record. The first child record may include an indication of a first device and a first source of an audio/video stream associated with the device. For example, the device may be a smartphone and a video stream from a universal serial bus (USB) capture device or screenshare application. The child record may further include an image associated with the device, such as a bezel image representative of the device. The method may next generate 320 a second child record which includes an indication of a second device, a second audio/video stream, and an image associated with the second device. While two child records are described here for exemplary purposes, any number of child records may be generated and presented.

The method is next operative to wait 322 for a start to the presentation. The start to the presentation may be determined in response to a user command from a user interface and/or a control signal from a coupled device, such as a remote control, or another video control device, such as a video processor, video production device or the like. If an indication of a start of the presentation has not been received, the method continues to wait 322 for a start to the presentation.

If an indication of the start 322 of the presentation is received, the method is configured to retrieve the parent record and the child record 1. The method then switches 325 a video input to the video stream 1 associated with the first device and as indicated in child record 1. The method then displays 330 the presentation according to the parent record, the child record 1, and the video stream 1.

While displaying the presentation according to the parent record, the child record 1, and the video stream 1, the method waits 332 for an indication to advance to the next slide. If no indication of a next slide is received, such as via a user input, the method continues to present the presentation according to the parent record, the child record 1, and the video stream 1. If an indication for a new slide is received, the method then retrieves 335 child record 2. The method then switches a video input to video stream 2 as indicated by child record 2. The method then displays the presentation according to the parent record, the child record 2 and the video stream 2.

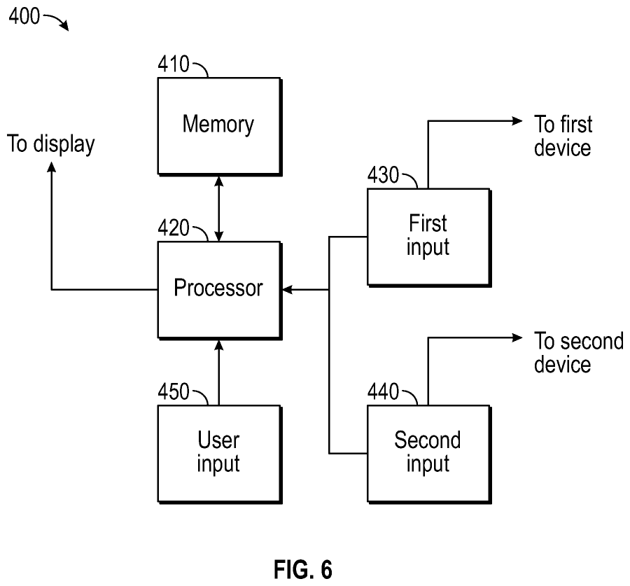

Turning now to FIG. 6, a block diagram illustrating a system 400 for presenting a demonstration of external device applications according to an exemplary embodiment of the present disclosure is shown. The exemplary system 400 may include a memory 410, a processor 420, a first input 430, a second input 440 and a user input 450.

The memory 410 may be a hard drive, flash drive, random access memory, or other electronic data storage device. The memory may be configured for storing presentation elements, such as background images, text, fonts, images and the like. In one example, the presentation element is a background image displayed on the first graphical user interface and the second graphical user interface The memory 410 may be further configured for storing data related to configuration of a presentation, such as parent records and client records. The memory 410 may also store graphics related to physical devices which may be used to generate video content for display during the presentation. The memory 410 may store a first graphic is a graphical representation of the first device and the second graphic is a graphical representation of the second device. For example, the first graphic may be an image of a smartphone having a display portion and a bezel portion surrounding the display portion.

The first input 430 may be an electronic input for receiving data from another electronic device. For example, the first input 430 may be a USB port for receiving a video stream generated by a webcam. The first input 430 may be configured to receive a screen capture from a mobile device, such as a smartphone. Furthermore, the first input 430 may correspond to an identifier, such as USB1 so that it may be accessed by the processor 420 when the processor 420 requires access to the data being received from the electronic device. Likewise, the second input 440 is configured for receiving data from an electronic device in a manner similar to that of the first input 430.

The user input 450 is configured for receiving a first user command defining a parent record including a presentation element, a first client record including the first device, and the first input, and a second client record including the second device and the second input; the user input further configured for receiving a first display command and a second display command. The user interface 450 may be a keyboard, mouse, touchscreen display, microphone for receiving voice commands or the like. The user interface 450 may include a display for displaying the presentation according to the parent record, the first client record and the second client record and for navigating between a first view and a second view in response to a user request received at the user interface 450.

The processor 420 may be configured for generating a user interface having a first view configured for displaying the first video content within a first graphic associated with the first device and the presentation element in response to the first display command. The first display command may be generated in response to a user command and may be received from the user input 450 and may be a slide advance command or the like. The first video content may be generated by the first device, such as a video stream from a webcam. Alternatively, the first video content may be a video capture of an operation performed by the first device, such as displaying a screen capture of a smartphone while an application is being operated by a user.

The processor 420 is further configured for generating a second view for displaying the second audio video content within a second graphic associated with the second external device in response to the second display command. The second display command may also be generated in response to receiving a user command via the user input 450. The processor 420 may be automatically coupled to the first input in response to the first display command and the second input in response to the second display command. The first view and the second view may be coupled by the processor 420 to a display configured for displaying the first view and the second view. In one example, the first view and the second view are generated in response to the parent record and the first client record or the parent record and the second client record. Thus, some data which may be consistent for the entire presentation, such as background, font type, and logo may be defined in the parent record and data which is specific to one particular view, such as text and a video stream from a particular device and an image associated with the particular device are identified in the client record.

The system 400 may be a system for generating a presentation including a user interface for receiving a first user command defining a parent record including a presentation element, a first client record including the first device, and the first input, and a second client record including the second device and the second input. The user input may be configured for receiving a first display command and a second display command. The processor may be configured for generating a user interface having a first view configured including the first video content within a first graphic associated with the first device and the presentation element and coupling the first view to a display device. The processor may further generate a second view including the second video content within a second graphic associated with the second external device and coupling the second view to the display device. The switching between the first view and the second view may be initiated in response to a second user command received at the user interface.

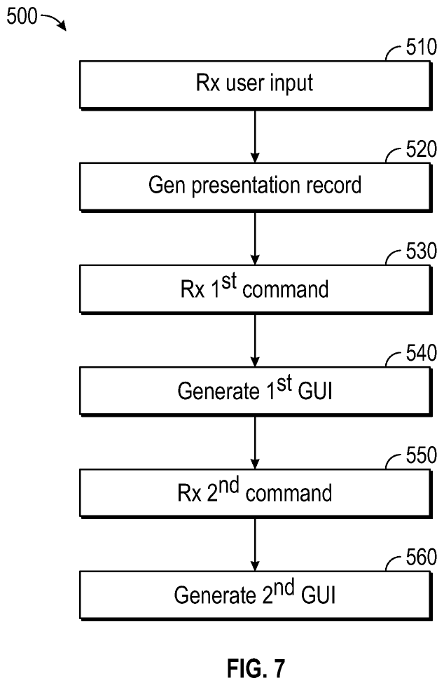

Turning now to FIG. 7, a flowchart illustrating a method 500 for presenting a demonstration of external device applications according to an exemplary embodiment of the present disclosure is shown. The method 500 is configured for provides a browser based demo presentation platform that mimics the functionality of a video processor and video switching matrix used at our online and live events. The exemplary method may display images, websites, video, and external device video output in a variety of bezels, with smooth transitions between each state. The external device video output may be captured using a USB video capture device and/or native video output from the device. The method may further display a picture in picture video of a presenter as well during a demo.

The exemplary method 500 is first configured for receiving 510, via a user interface, a user input indicative of a presentation element, a first device, a first video source associated with the first device, a second device and a second video source associated with the second device. The user interface may be a keyboard, mouse or other human machine interface. The user input may be generated in response to a graphical menu selection algorithm. The data as indicated by the user input, such as the presentation record, the first client record, the second client record and the presentation element may be stored in a memory coupled to the processor for performing the method.

In response to the user input, the method generates 520 a presentation record including the presentation element, a first client record indicative of a first image associated with the first device and the first video source, and a second client record indictive of a second image associated with the second device and the second video source. The presentation record may be generated by a processor or the like and stored in a memory.

Once the presentation record is generated and stored in a memory accessible to a processor performing the method, the method is next operative for receiving 530, via the user interface, a first command to display a first portion of the presentation. This first command may be a loading of the presentation, a starting of the presentation, or an advancement of the presentation to a graphical user interface as defined, in part, by the first client record. In response, the processor then generates 540 a first graphical user interface in response to the parent record and the first client record displaying the presentation element and a first video stream received via the first video source overlayed over a portion of the first image. In one example, the first video stream may be generated by the first device or, alternatively, may be a video capture of an operation performed by the first device. The processor may be coupled to the first video source automatically in response to the first command to display the first portion of the presentation in response to data provided in the first client record.

Next the exemplary method receives 550, via the user interface, a second command to display a second portion of the presentation. This second command may be generated in response to a user input on the user interface requesting to advance the presentation to the graphical user interface as defined, in part, by the second client record.

In response to the second command a second graphical user interface is generated 560 by the processor in response to the parent record and the second client record displaying the presentation element and a second video stream received via the second video source overlayed over a portion of the second image. In one example, the processor is coupled to the second video source in response to the second command to display the second portion of the presentation in response to data provided in the second client record. The first graphical user interface and the second graphical user interface may be displayed on a display device such as a presentation screen for presenting the demonstration to a large audience. In addition, the presentation may be streamed over a network connection to an individual viewer or a small group of viewers at an alternate location.

The first image may include a graphical representation of the first device and the second image is a graphical representation of the second device. For example, the first image is an image of a bezel surrounding a display portion of the first device. In addition, the presentation element may be a background image displayed on the first graphical user interface and the second graphical user interface.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

The various tasks performed in connection with the process may be performed by software, hardware, firmware, or any combination thereof. For illustrative purposes, the following description of process may refer to elements mentioned above. In practice, portions of process may be performed by different elements of the described system, e.g., component A, component B, or component C. It should be appreciated that process may include any number of additional or alternative tasks, the tasks shown need not be performed in the illustrated order, and process may be incorporated into a more comprehensive procedure or process having additional functionality not described in detail herein. Moreover, one or more of the tasks shown could be omitted from an embodiment of the process as long as the intended overall functionality remains intact.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method comprising:
receiving, via a user interface, user input indicative of a presentation element, a first device, a first video source associated with the first device, a second device and a second video source associated with the second device;
generating, by a processor, a presentation record including the presentation element, a first client record indicative of a first image associated with the first device and the first video source, and a second client record indictive of a second image associated with the second device and the second video source;
receiving, via the user interface, a first command to display a first portion of the presentation;
generating, by the processor, a first graphical user interface in response to the presentation record and the first client record displaying the presentation element and a first video stream received via the first video source overlayed over a portion of the first image;
receiving, via the user interface, a second command to display a second portion of the presentation; and
generating, by the processor, a second graphical user interface in response to the presentation record and the second client record displaying the presentation element and a second video stream received via the second video source overlayed over a portion of the second image.

2. The method of claim 1, wherein the first image is a graphical representation of the first device and the second image is a graphical representation of the second device.

3. The method of claim 1, wherein the presentation element is a background image displayed on the first graphical user interface and the second graphical user interface.

4. The method of claim 1, wherein the first video stream is generated by the first device.

5. The method of claim 1, wherein the first video stream is a video capture of an operation performed by the first device.

6. The method of claim 1, wherein the first image is an image of a bezel surrounding a display portion of the first device.

7. The method of claim 1, where the presentation record, the first client record, the second client record and the presentation element are stored in a memory coupled to the processor.

8. The method of claim 1, wherein the first graphical user interface and the second graphical user interface are displayed on a display device.

9. The method of claim 1 wherein the processor is coupled to the first video source in response to the first command to display the first portion of the presentation and the processor is coupled to the second video source in response to the second command to display the second portion of the presentation.

10. An apparatus for providing a user interface comprising:
a memory configured to store a presentation element;
a first input configured to receive a first video content from a first device;
a second input configured to receive a second video content from a second device;
a user input configured to receive a first user command defining a parent record including a presentation element, a first client record including the first device, and the first input, and a second client record including the second device and the second input; the user input further configured for receiving a first display command and a second display command;
a processor configured to generate a user interface having a first view configured for displaying the first video content within a first graphic associated with the first device and the presentation element in response to the first display command, and a second view for displaying the second audio video content within a second graphic associated with the second external device in response to the second display command; and
a display configured for displaying the first view and the second view.

11. The apparatus for providing the user interface of claim 10, wherein the first graphic is a graphical representation of the first device and the second graphic is a graphical representation of the second device.

12. The apparatus for providing the user interface of claim 10, wherein the presentation element is a background image displayed on the first graphical user interface and the second graphical user interface.

13. The apparatus for providing the user interface of claim 10, wherein the first video content is generated by the first device.

14. The apparatus for providing the user interface of claim 10, wherein the first video content is a video capture of an operation performed by the first device.

15. The apparatus for providing the user interface of claim 10, wherein the first graphic is an image of a bezel surrounding a display portion of the first device.

16. The apparatus for providing the user interface of claim 10, wherein the first view is generated in response to the parent record and the first client record.

17. The apparatus for providing the user interface of claim 10, wherein the processor is coupled to the first input in response to the first display command and the second input in response to the second display command.

18. The apparatus for providing the user interface of claim 10, wherein the memory is further configured for storing the parent record, the first client record and the second client record.

19. A system for generating a presentation comprising:
a user interface configured to receive user commands defining a parent record including a presentation element, a first client record including the first device, and the first input, and a second client record including the second device and the second input; the user interface further configured for receiving a first display command and a second display command; and
a processor configured to generate a user interface having a first view configured including the first video content within a first graphic associated with the first device and the presentation element and coupling the first view to a display device, the processor further configured for generating a second view including the second video content within a second graphic associated with the second external device and coupling the second view to the display device.

20. The system for generating a presentation of claim 19, wherein switching between the first view and the second view is initiated in response to a second user command received at the user interface.
